(19) United States
(12) Patent Application Publication
(10) Pub. No.: US 2018/0344083 A1
(43) Pub. Date: Dec. 6, 2018

(54) Food heating device

(71) Applicant: Gregory MAK, KWUN TONG (HK)

(72) Inventor: Gregory MAK, KWUN TONG (HK)

(21) Appl. No.: 15/993,581

(22) Filed: May 30, 2018

(30) Foreign Application Priority Data
May 31, 2017 (CN) 201720623010.X

(51) Int. Cl. A47J 36/28; B65D 81/34; A47J 36/24

(52) U.S. Cl. CPC A47J 36/28; A47J 36/2405; B65D 81/3484

(57) ABSTRACT

A food heating device having a heat pack containing heating agents that react chemically to release heat when come into contact with water, and a container for containing the heat pack; the container has a water capacity that allows the container to hold an amount of water capable of allowing the heat pack to chemically react with so that the heat pack releases heat to heat the food.

### BACKGROUND OF THE INVENTION

The present invention relates to a heating device, and more specifically relates to a kind of heating device primarily for heating food.

Nowadays, many buffet restaurants offer food in different metal food trays so that customers can take any food their want. Each of the metal food trays is usually mounted on another metal tray which contains water. Said another metal tray containing water is disposed on a metal rack. A heater is positioned below the metal rack to heat up the water inside said another metal tray. The heated water will in turn heat the food on the metal food tray above said another metal tray so as to keep the food warm. However, the heater below the metal rack is accessible by customers who can easily get burnt by the heater. Accidents can also easily happen to restaurant staff when they replace the food or when they ignite or turn off the heater.

### BRIEF SUMMARY OF THE INVENTION

In view of the aforesaid disadvantages now present in the prior art, the present invention provides a food heating device which is safe and simple to use.

The present invention is achieved as follows:

A food heating device, comprising:

a heat pack; the heat pack contains heating agents that react chemically to release heat when come into contact with water;

a container for containing the heat pack; the container has a water capacity that allows the container to hold an amount of water capable of allowing the heat pack to chemically react with so that the heat pack releases heat to heat the food;

a marking, provided at an inner periphery of the container near to an opening of the container to indicate the amount of water capable of allowing the heat pack to chemically react with so as to release heat to heat the food;

the opening of the container is sealed by a removable cover to avoid accidental leakage of water that contacts with the heat pack causing the heat pack to heat up accidentally;

the container is a disposable container;

the heat pack is placed into a sealed plastic bag to avoid contact with water leaked out accidentally that causes the heat pack to heat up accidentally;

the food heating device also comprises a tray; the tray is provided with a movably connected separating element that divides the tray into an upper portion and a lower portion; the lower portion of the tray is provided with one or more than one of said container each containing the heat pack; the upper portion of the tray is provided with the food required to be heated; the separating element has ventilation holes to vent out vapor produced by the heat pack when the heat pack releases heat;

a tray cover is movably connected with the tray; the tray cover also has ventilation holes to vent out the vapor produced by the heat pack when the heat pack releases heat.

The present invention is operated as follows:

Taking out the heat pack from the sealed plastic bag, removing the removable cover of the container, placing the heat pack in the container, and then placing the container containing the heat pack in the lower portion of the tray; pouring water into the container until the container is full to provide enough amount of water for the heat pack to chemically react with so as to release heat to heat the food; it is not necessary to measure the amount of water to be poured in, because the water capacity of the container is preset to allow the container to hold water enough for the heat pack to chemically react so that the heat pack releases heat to heat the food; next, placing the separating element in the tray and placing the food on the separating element; if necessary, covering the tray by the tray cover to enhance the heating effect. Because of the ventilation holes on the separating element and the tray cover, the vapor produced by the heat pack when the heat pack releases heat can be vented out through the ventilation holes, thereby preventing explosion. The present invention can replace the heater currently used in restaurant below the metal tray. Further, the restaurant can keep using the existing metal trays and metal food trays without the need of purchasing new equipment to adapt to the use of the present invention.

### BRIEF DESCRIPTION OF THE DRAWINGS

FIG. 1 is a structural view of the present invention.

FIG. 2 is another structural view of the present invention.

FIG. 3 is still another structural view of the present invention.

FIG. 4 is yet another structural view of the present invention.

### DETAILED DESCRIPTION OF THE INVENTION

The present invention will be further described in detail below with reference to some embodiments and the accompanying drawings. It should be noted that the present invention is not limited by the embodiments disclosed herein.

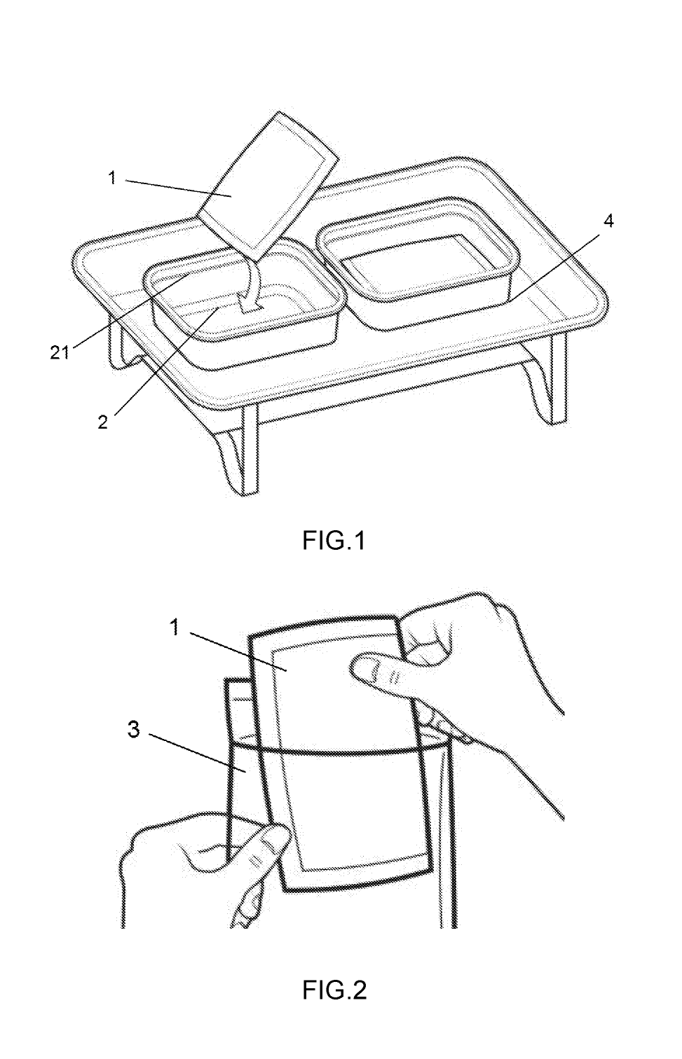

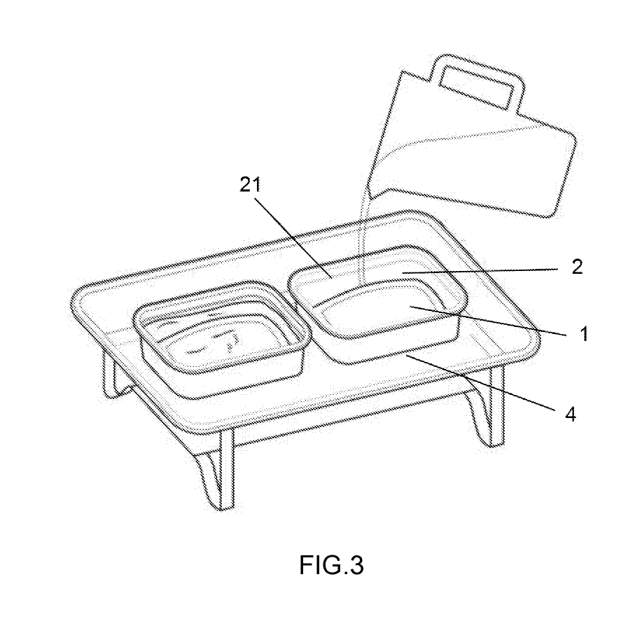

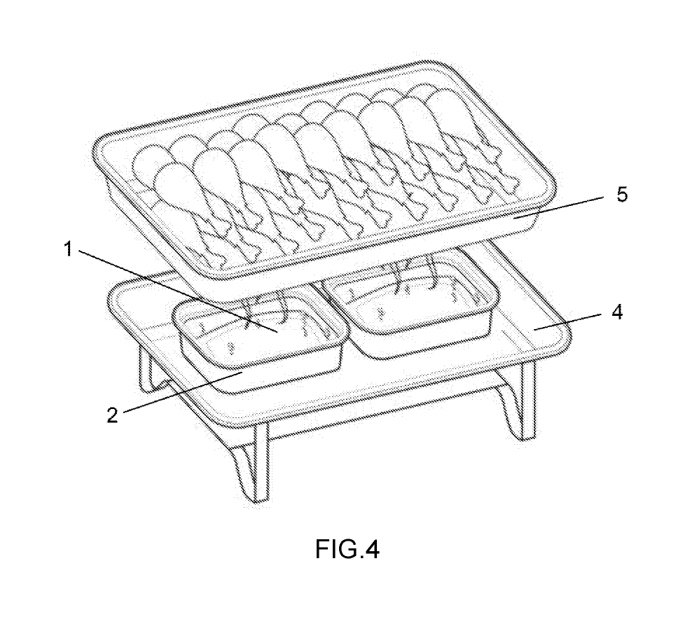

FIGS. 1-4 illustrate an embodiment of the present invention. As shown in the figures, a food heating device comprises a heat pack 1 and a container 2 for containing the heat pack 1. The heat pack 1 contains heating agents that react chemically to release heat when come into contact with water. The heating agents are prior arts and will not be described in detail with respect of their structures and operating principles. The container is a disposable container having a water capacity that can hold water enough for the heat pack 1 to chemically react with so that the heat pack 1 can release heat to heat the food. In the present invention, a marking 21 is provided at an inner periphery of the container 2 near to an opening thereof to indicate an amount of water capable of allowing the heat pack 1 to chemically react with so as to release heat to heat the food. The opening of the container 2 can be sealed by a removable cover (not shown in the figure) to avoid accidental leakage of water that contacts with the heat pack 1 causing the heat pack 1 to heat up accidentally. The heat pack 1 can be placed into a sealed plastic bag 3 to avoid contact with water leaked out accidentally that causes the heat pack 1 to heat up accidentally.

The food heating device also comprises a tray 4. The tray 4 is provided with a movably connected separating element 5 that divides the tray 4 into an upper portion and a lower portion. The lower portion of the tray 4 is provided with one or more containers 2 each containing the heat pack 1. The upper portion of the tray 4 is provided with food required to be heated. The separating element 5 has ventilation holes (not shown in the figures) to vent out vapor produced by the heat pack 1 when the heat pack releases heat. A tray cover (not shown in the figures) is movably connected with the tray 4. The tray cover also has ventilation holes to vent out the vapor produced by the heat pack 1 when the heat pack releases heat.

The food heating device of the present invention is operated as follows:

Taking out the heat pack 1 from the sealed plastic bag 3, removing the removable cover of the container 2, placing the heat pack 1 in the container, and then placing the container 2 containing the heat pack 1 in the lower portion of the tray 4; pouring water into the container 2 until the container 2 is full or until the water level reaches the marking 21 to provide enough amount of water for the heat pack 1 to chemically react with so as to release heat to heat the food; it is not necessary to measure the amount of water to be poured in, because the water capacity of the container 2 is preset to hold water enough for the heat pack 1 to chemically react for the heat pack 1 to release heat to heat the food; next, placing the separating element 5 in the tray 4 and placing the food on the separating element; if necessary, covering the tray 4 by the tray cover to enhance the heating effect. Because of the ventilation holes on the separating element and the tray cover, the vapor produced by the heat pack 1 when the heat pack 1 releases heat can be vented out through the ventilation holes, thereby preventing explosion.

In other embodiments, the tray can also be other containers suitable for food heating, for example, a Chinese steam cage.

The embodiments described above are only the preferred embodiments of the present invention. It should be noted that the present invention should not be limited to the embodiments described above. Any changes, modifications, replacements, combinations and simplification without deviating from the essence and principle of the present invention should be considered alternative configurations that achieve the same technical effects, and should therefore fall within the scope of protection of the present invention.

What is claimed is:

1. A food heating device, comprising:
a heat pack; the heat pack contains heating agents that react chemically to release heat when come into contact with water;
a container for containing the heat pack; the container has a water capacity that allows the container to hold an amount of water capable of allowing the heat pack to chemically react with so that the heat pack releases heat to heat the food.

2. The food heating device of claim 1, wherein a marking is provided at an inner periphery of the container near to an opening of the container to indicate the amount of water capable of allowing the heat pack to chemically react with so as to release heat to heat the food.

3. The food heating device of claim 1, wherein an opening of the container is sealed by a removable cover.

4. The food heating device of claim 1, wherein the container is a disposable container.

5. The food heating device of claim 1, wherein the heat pack is placed into a sealed plastic bag.

6. The food heating device of claim 1, wherein the food heating device also comprises a tray; the tray is provided with a movably connected separating element that divides the tray into an upper portion and a lower portion; the lower portion of the tray is provided with one or more than one of said container each containing the heat pack; the upper portion of the tray is provided with the food required to be heated; the separating element has ventilation holes.

7. The food heating device of claim 6, wherein a tray cover is movably connected with the tray; the tray cover also has ventilation holes.
